(19) United States
(12) Patent Application Publication
(10) Pub. No.: US 2013/0318368 A1
(43) Pub. Date: Nov. 28, 2013

(54) POWER MANAGEMENT SYSTEM AND METHOD FOR SERVER

(71) Applicants: HON HAI PRECISION INDUSTRY CO., LTD., New Taipei (TW); HONG FU JIN PRECISION INDUSTRY (ShenZhen) Co., LTD, Shenzhen (CN)

(72) Inventor: WEI-DONG CONG, Shenzhen (CN)

(73) Assignees: HON HAI PRECISION INDUSTRY CO., LTD., New Taipei (TW); HONG FU JIN PRECISION INDUSTRY (ShenZhen) Co., LTD, Shenzhen (CN)

(21) Appl. No.: 13/894,467

(22) Filed: May 15, 2013

(30) Foreign Application Priority Data
May 25, 2012 (CN) 2012101659125

(51) Int. Cl. G06F 1/26

(52) U.S. Cl. CPC G06F 1/263
USPC 713/300

(57) ABSTRACT

A power management system includes a number of motherboards, a power supply unit, a number of first electronic switches coupled to the motherboards respectively, and a processor. The power supply unit includes first and second power units. First terminals of the first electronic switches are coupled to the second power unit, second terminals of the first electronic switches are coupled to the corresponding motherboards, and third terminals of the first electronic switches are coupled to the processor. The processor obtains statuses of the motherboards to determine whether there exists at least one of the motherboards needing to bootstrap, the processor outputs a switch signal to the third terminal of the electronic switch coupled to the motherboard that needs to bootstrap, in response to there existing at least one of the motherboards needing to bootstrap.

### BACKGROUND

1. Technical Field

The present disclosure relates to a power management system, and particularly to an energy-saving power management system.

2. Description of Related Art

A server may include one or more motherboards acquiring power from a power supply unit. However, operation modes of the motherboards may be different. For instance, a first motherboard may be in an operation mode, while a second motherboard may be in a sleep mode. If the power supply unit powers the first and second motherboards in a same way, the second motherboard will still consume a certain power, which may result in increased power consumption of the server.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a power management system of the present disclosure.

FIG. 2 is a flow chart of an embodiment of a power management method of the present disclosure.

### DETAILED DESCRIPTION

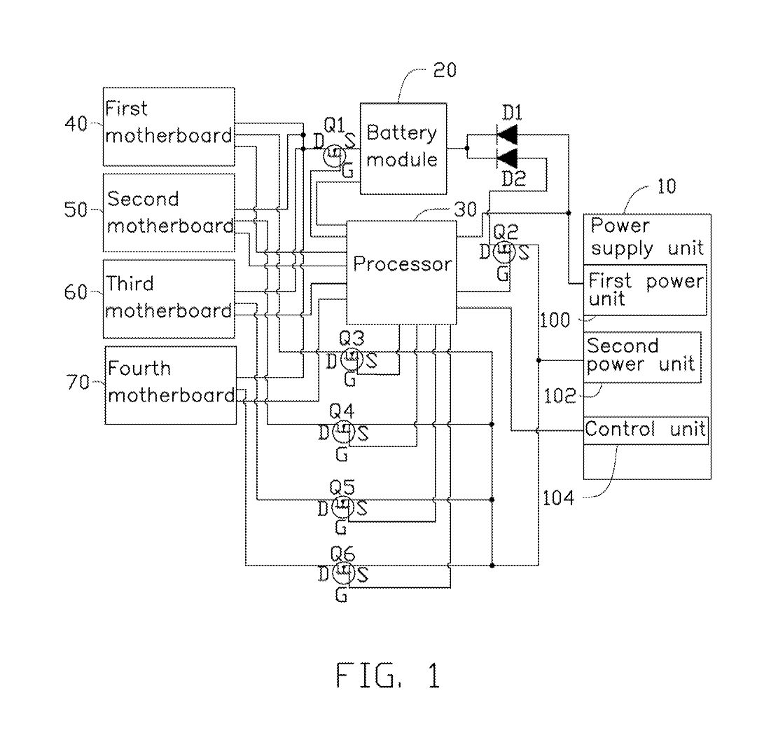

FIG. 1 shows an embodiment of a power management system of the present disclosure. The power management system includes a power supply unit 10, a battery module 20, a processor 30, six electronic switches Q1-Q6, two diodes D1 and D2, and first to fourth motherboards 40, 50, 60, and 70.

The power supply unit 10 includes a first power unit 100, a second power unit 102, and a control unit 104. The first power unit 100 is coupled to an anode of the diode D1 and the processor 30. A cathode of the diode D1 is coupled to the battery module 20. The second power unit 102 is coupled to a first terminal of the electronic switch Q2. A second terminal of the electronic Q2 is coupled to an anode of the diode D2. A cathode of the diode D2 is coupled to the battery module 20. A third terminal of the electronic switch Q2 is coupled to the processor 30 to receive a switch signal from the processor 30, thereby enabling the second power unit 102 to charge the battery module 20 when the electronic switch Q2 is turned on. The second power unit 102 is coupled to first terminals of the electronic switches Q3-Q6. Second terminals of the electronic switches Q3-Q6 are coupled to the first to fourth motherboards 40, 50, 60, and 70, respectively. Third terminals of the electronic switches Q3-Q6 are coupled to the processor 30, to receive switch signals from the processor 30. The processor 30 is also directly coupled to the battery module 20.

A first terminal of the electronic switch Q1 is coupled to the battery module 20. A second terminal of the electronic switch Q1 is coupled to the first to fourth motherboards 40, 50, 60, and 70. A third terminal of the electronic switch Q1 is coupled to the processor 30, to receive a switch signal from the processor 30. The motherboards 40-70 are directly coupled to the processor 30, thereby enabling the processor 30 to turn on or off the corresponding electronic switches Q3-Q6 according to the statuses of the motherboards 40-70 detected by the processor 30.

When the third terminals of the electronic switches Q1-Q6 receive high level switch signals, such as logic 1, the electronic switches Q1-Q6 are turned on, such that the first terminals of the electronic switches Q1-Q6 are connected to the corresponding second terminals of the electronic switches Q1-Q6, respectively. When the third terminals of the electronic switches Q1-Q6 receive low level switch signals, such as logic 0, the electronic switches Q1-Q6 are turned off, such that the first terminals of the electronic switches Q1-Q6 are disconnected from the corresponding second terminals of the electronic switches Q1-Q6, respectively. In this illustrated embodiment, the electronic switches Q1-Q6 are n-channel metal oxide semiconductor transistors (NMOS), where gates, drains, and sources of the NMOS are the third, second, and first terminals of the electronic switches Q1-Q6. In other embodiments, the electronic switches Q1-Q6 are npn transistors, where bases, collectors, and emitters of the npn transistors are the third, second, and first terminals of the electronic switched Q1-Q6.

When the power supply unit 10 is connected to a power source, such as the commercial power, the control unit 104 can control the first power unit 100 to output a standby voltage, to charge the battery module 20 through the diode D1, and control the second power unit 102 to output a power-on voltage, to power on the motherboards according to need, and/or to charge the battery module 20 through the electronic switch Q2 operated by the processor 30.

The processor 30 determines whether the power supply unit 10 is connected to a power source, which is performed by detecting whether the first power unit 100 outputs the standby voltage. When the power supply unit 10 is connected to a power source, the first power unit 100 charges the battery module 20 through the diode D1. The processor 30 outputs a high level switch signal to the third terminal of the electronic switch Q1, the electronic switch Q1 is turned on, and the battery module 20 then provides power to the first to fourth motherboard 40, 50, 60, and 70. In another embodiment, the processor 30 also obtains a residual voltage of the battery module 20, and determines whether the residual voltage of the battery module 20 is less than a predetermined value. The battery module 20 will not be able to provide power to the first to fourth motherboards 40, 50, 60, and 70 in response to the residual voltage of the battery module 20 being less than the predetermined value. The processor 30 outputs a high level switch signal to the third terminal of the electronic switch Q2, the electronic switch Q2 is turned on, so that the second power unit 102 provides power to the battery module 20, to charge the battery module 20. When the residual voltage of the battery module 20 is not less than the predetermined value, the processor 30 may output a low level switch signal to the third terminal of the electronic switch Q2, to enable the electronic switch Q2 to be turned off.

The processor 30 further obtains statuses of the first to fourth motherboards 40, 50, 60, and 70, to determine whether there exists at least one of the first to fourth motherboards 40, 50, 60, and 70 needing to bootstrap. If there exists at least one motherboard needing to bootstrap, the processor 30 enables the control unit 104 of the power supply unit 10 to control the second power unit 102 to output the power-on voltage. The processor 30 outputs a high level switch signal to the third terminal of the corresponding electronic switch coupled to the motherboard that needs to bootstrap. Accordingly, the motherboard that needs to bootstrap can acquire power from the second power unit 102. When all the first to fourth motherboards 40, 50, 60, and 70 do not need to bootstrap, the processor 30 outputs low level switch signals to the third to sixth electronic switches Q3-Q6 to turn off the third to sixth electronic switches Q3-Q6, to ensure that the second power unit 102 does not provide power to all the motherboards 40-70. Consequently, the processor 30 can enable the power supply unit 10 to provide power to the motherboard that needs to bootstrap, and not provide power to the motherboard that does not need to bootstrap, which can reduce the consumption of first to fourth motherboards 40, 50, 60, and 70.

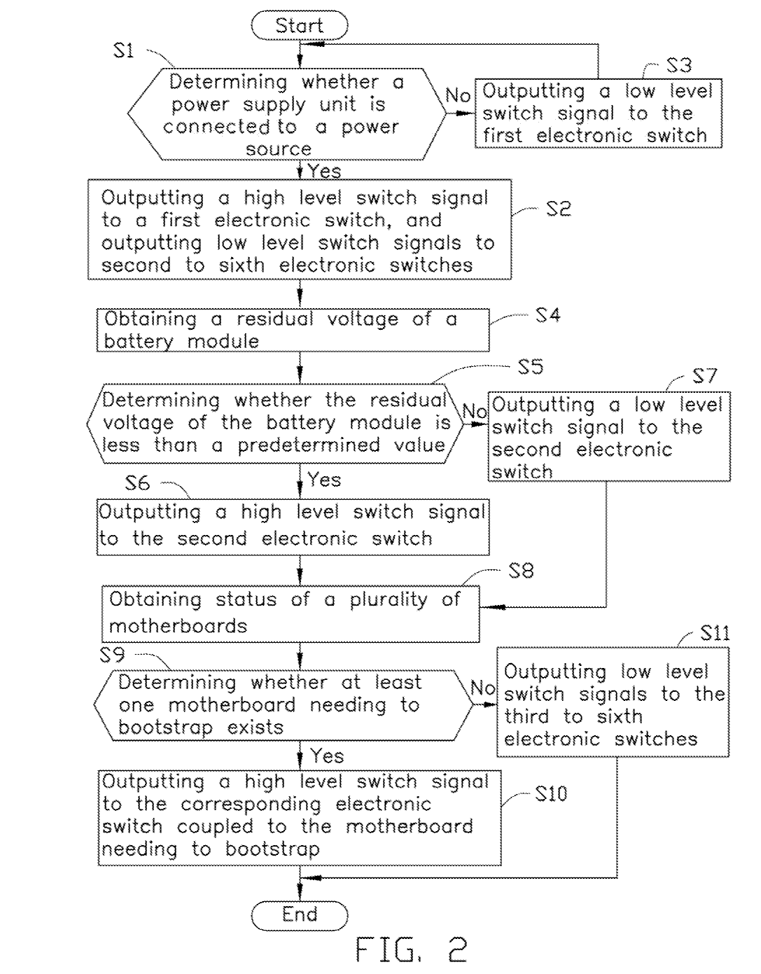

FIG. 2 shows a power management method of the present disclosure including the following steps.

In step S1, the processor 30 determines whether the power supply unit 10 is connected to a power source. If the power supply unit 10 is connected to a power source, step S2 is implemented, otherwise, step S3 is implemented.

In step S2, the processor 30 outputs a high level switch signal to the electronic switch Q1, and outputs low level switch signals to the electronic switches Q2-Q6, and step S4 is implemented. Accordingly, the first to fourth motherboards 40, 50, 60, and 70 can acquire power from the battery module 20, and the statuses of all the motherboards 40-70 can be obtained by the processor 30.

In step S3, the processor 30 outputs a low level switch signal to the third terminal of the electronic switch Q1, and the process returns to the step S1. When the power supply unit 10 is not connected to a power source, it indicates that the first to fourth motherboard 40, 50, 60, and 70 do not need to bootstrap. It is an effective way to further reduce the consumption by controlling the battery module 20 not to provide power to the first to fourth motherboards 40, 50, 60, and 70.

In step S4, the processor 30 obtains the residual voltage of the battery module 20.

In step S5, the processor 30 determines whether the residual voltage of the battery module 20 is less than a predetermined value. If the residual voltage of the battery module 20 is less than the predetermined value, step S6 is implemented. Otherwise, step S7 is implemented.

In step S6, the processor 30 outputs a high level switch signal to the third terminal of the electronic switch Q2, to enable the second power unit 102 to charge the battery module 20, and step S8 is implemented.

In step S7, the processor 30 outputs a low level switch signal to the third terminal of the electronic switch Q2, to enable the second power unit 102 not to charge the battery module 20, and step S8 is implemented.

In step S8, the processor 30 obtains the statuses of the first to fourth motherboard 40, 50, 60, and 70.

In step S9, the processor 30 determines whether there exists at least one motherboard needing to bootstrap. If there exists at least one motherboard needing to bootstrap, step S10 is implemented. Otherwise, step S11 is implemented.

In step S10, the processor 30 outputs a high level switch signal to the corresponding electronic switch coupled to the motherboard that needs to bootstrap. The process ends.

In step S11, the processor 30 outputs low level switch signals to the third terminal of the third to sixth electronic switches Q3-Q6. The process ends.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power management system, comprising:
a plurality of motherboards;
a power supply unit comprising a first power unit to output a standby voltage in response to the power supply unit being connected to a power source, a second power unit, and a control unit configured to control the second power unit to output a power-on voltage;
a plurality of first electronic switches each comprising first to third terminals, wherein the first terminals of the plurality of first electronic switches are coupled to the second power unit, the second terminals of the plurality of first electronic switches are coupled to the corresponding motherboards; and
a processor coupled to the plurality of motherboards, the first power unit, the control unit, and the third terminals of the plurality of first electronic switches, wherein the processor determines whether the power supply unit is connected to a power source by detecting a standby voltage outputted by the first power unit, the processor obtains statuses of the plurality of motherboards to determine whether there exists at least one of the motherboards needing to bootstrap, the processor outputs a switch signal to the third terminal of the first electronic switch coupled to the motherboard that needs to bootstrap, in response to there existing at least one of the motherboards needing to bootstrap.

2. The power management system of claim 1, wherein the processor outputs a high level switch signal to the third terminal of the first electronic switch coupled to the motherboard that needs to bootstrap, when the third terminals of the plurality of first electronic switches receive high level switch signals, the first terminals of the plurality of first electronic switches are connected to the second terminals of the corresponding first electronic switches, when the third terminals of the plurality of first electronic switches receive low level switch signals, the first terminals of the plurality of first electronic switches are disconnected from the second terminals of the corresponding first electronic switches.

3. The power management system of claim 2, further comprising a battery module and a second electronic switch, wherein the first power unit is coupled to the battery module, to charge the battery module, a first terminal of the second electronic switch is coupled to the battery module, a second terminal of the second electronic switch is coupled to the plurality of motherboards, a third terminal of the second electronic switch is coupled to the processor, when the power supply unit is connected to a power source, the processor outputs a high level switch signal to the third terminal of the second electronic switch, to enable the battery module to provide power to the plurality of motherboards, wherein when the third terminal of the second electronic switch receives a high level switch signal, the first terminal of the second electronic switch is connected to the second terminal of the second electronic switch, when the third terminal of the second electronic switch receives a low level switch signal, the first terminal of the second switch is disconnected from the second terminal of the second electronic switch.

4. The power management system of claim 3, further comprising a third electronic switch, wherein a first terminal of the third electronic switch is coupled to the second power unit, a second terminal of the third electronic switch is coupled to the battery module, a third terminal of the third electronic switch is coupled to the processor, the processor determines whether a residual voltage of the battery module is less than a predetermined value, the processor outputs a high level switch signal to the third terminal of the third electronic switch responsive to the residual voltage of the battery being less than the predetermined value, wherein when the third terminal of the third electronic switch receives a high level switch signal, the first terminal of the third electronic switch is connected to the second terminal of the third electronic switch, when the third terminal of the third electronic switch receives a low level switch signal, the first terminal of the third electronic switch is disconnected from the second terminal of the third electronic switch.

5. The power management system of claim 4, wherein when the power supply unit is not connected to a power source, the processor outputs the low level switch signal to the third terminal of the second electronic switch, to prevent the battery module from providing power to the plurality of motherboards.

6. The power management system of claim 4, wherein when none of the plurality of motherboards need to bootstrap the processor enables the control unit of the power supply unit not to control the second power unit to output the power-on voltage.

7. The power management system of claim 4, wherein the first to third electronic switches are n-channel metal oxide semiconductor transistors, wherein emitters, collectors, and gates of the n-channel metal oxide semiconductor transistors are the first, second, and third terminals of the first to third electronic switches, respectively.

8. A power management method, comprising:
determining whether a power supply unit comprising a first and second power units is connected to a power source;
obtaining statuses of a plurality of motherboards coupled to the second power unit of the power supply unit through a plurality of first electronic switches, responsive to the power supply unit being connected to a power source;
determining whether there exists at least one of the plurality of motherboards needing to bootstrap; and
outputting a high level switch signal to the first electronic switch coupled to the motherboard that needs to bootstrap, to power on the corresponding motherboard.

9. The power management method of claim 8, before the obtaining step, further comprising:
providing power to the plurality of motherboards through a second electronic switch by a battery module acquiring power from the first power unit of the power supply.

10. The power management method of claim 9, further comprising:
obtaining a residual voltage of the battery module;
determining whether the residual voltage of the battery module is less than a predetermined value; and
outputting a high level switch signal to a third electronic switch to enable the second power unit of the power supply to charge the battery module, in response to the residual voltage of the battery being less than the predetermined value.

11. The power management method of claim 10, further comprising:
outputting a low level switch signal to the second electronic switch to stop providing power to the plurality of motherboards in response to there exists any one of the plurality of motherboards needing to bootstrap.

12. The power management method of claim 10, further comprising:
controlling the second power unit to stop providing power to the plurality of motherboards in response to the power supply unit not being connected to a power source.
